(19) United States
(12) Patent Application Publication
(10) Pub. No.: US 2007/0013475 A1
(43) Pub. Date: Jan. 18, 2007

(54) Remote control system for controlling apparatus in response to a variable

(75) Inventor: Michael Dennis Hardwick, Dorchester (GB)

Correspondence Address: ARTHUR JACOB, 25 EAST SALEM STREET, P.O. BOX 686, HACKENSACK, NJ, 07602, US

(73) Assignee: Intelligent Electris(Intellectual Property)Limited, Dorchester (GB)

(21) Appl. No.: 10/567,316

(22) PCT Filed: Aug. 6, 2004
(86) PCT No.: PCT/GB04/03427

§ 371 Date: Jul. 31, 2006

(30) Foreign Application Priority Data
Aug. 6, 2003 (GB) 0318380.3

(51) Int. Cl. G05B 23/02; G08C 19/00

(52) U.S. Cl. 340/3.1; 236/49.3; 315/150; 340/825.69

(57) ABSTRACT

A hotel floor comprises rooms each provided with a central heating radiator having a valve adjustable by means of a 0-10V dc stepper motor. In the hotel lobby a sensor for ambient temperature is connected to a radio transmitter and radio receivers are connected to the stepper motors in each room. If the ambient temperature falls, the transmitter transmits to the receivers a signal representing the lower temperature, and the stepper motors open the valves. If the temperature rises, the transmitter transmits another signal, and the stepper motors close the valves. Thus, the heat output of the radiators is varied in inverse relation to the ambient temperature. The system may otherwise control lighting fittings by way of dimming ballasts, and may also include person-detectors, timers and further control components.

This invention concerns the remote control of apparatus, especially but not exclusively for reducing power consumed thereby.

Apparatus such as electric heaters and lights consumes power when it is on, and everybody knows that power (and its cost) can be saved by switching such apparatus off when it is not needed. Unfortunately, for both environmental and economic concerns, this is not always done. People forget to switch lights off, for instance, or they cannot be bothered, or it is simply too troublesome. Heaters usually include some kind of thermostatic control, but this may well be set unduly high, and in the case of an electric heater the thermostat conventionally responds to temperature at the heater, rather than to ambient temperature.

It is therefore a first object of the present invention to provide a control system for apparatus such as heaters and lights which controls the output of the apparatus automatically in response to ambient temperature or light level or some other variable.

It is known to provide in buildings such as hotels, factories and shopping malls management systems in which control signals from a variety of sensors are used to control lights, heaters and other apparatus. Conventionally, however, the connections between the sensors and the controllers are hard-wired, which means that such building management systems (often called BMS systems) lack flexibility and are expensive (not least in redecoration) whenever some change of layout is required.

It is therefore a second object of the present invention to provide a control system such as a building management system in which the control signals are transmitted from sensor to controller by radio.

Thus according to the invention there is provided a control system for controlling apparatus remotely in response to a variable which is independent of the system and has a changing value, which system comprises a sensor to sense the value of the variable, a radio transmitter associated with the sensor and operative to transmit a control signal representative of the sensed value of the variable, a radio receiver associated with the controlled apparatus and operative to receive the control signal, and a controller operative automatically by receipt of the control signal to control the apparatus according to the value of the variable.

The variable may be, for instance, ambient light or temperature or some other variable arising or created outside of the system, such as the presence or absence of persons in a building.

Preferably the controller is operative to change a parameter of the apparatus as the value of the variable changes, eg in proportion thereto.

The parameter may be changed in direct relation to the value of the variable. However there are many applications of the present invention in which it is beneficial rather to change the parameter in inverse relation to the value of the natural variable: thus, for instance, output from lamps may be increased automatically as ambient light value falls, or output from heaters may be increased automatically as ambient temperature falls. Alternatively the sensor may sense the presence of a person and the system arranged to switch the apparatus on, or increase the output from the apparatus, when the presence of a person is detected. And this arrangement may include a timer operative to switch the lamps off, or reduce the light output from the lamp, a predetermined period after the time when the presence of a person is last sensed.

Whilst the parameter might be changed continuously, we have found that in practice it is sufficient—and more easily implemented—if the parameter is changed in a plurality of steps.

The control signals are preferably radio signals in the 868 MHz band.

The control system preferably includes a plurality of sensors and controllers. Also, the controllers may be operative in response to control signals from more than one sensor; for instance controllers may switch the controlled apparatus on, or increase its output, in response to a control signal from one said sensor and switch the controlled apparatus off, or decrease its output, in response to a control signal from another said sensor.

The invention will now be described by way of example only with reference to the accompanying schematic drawing, in which—

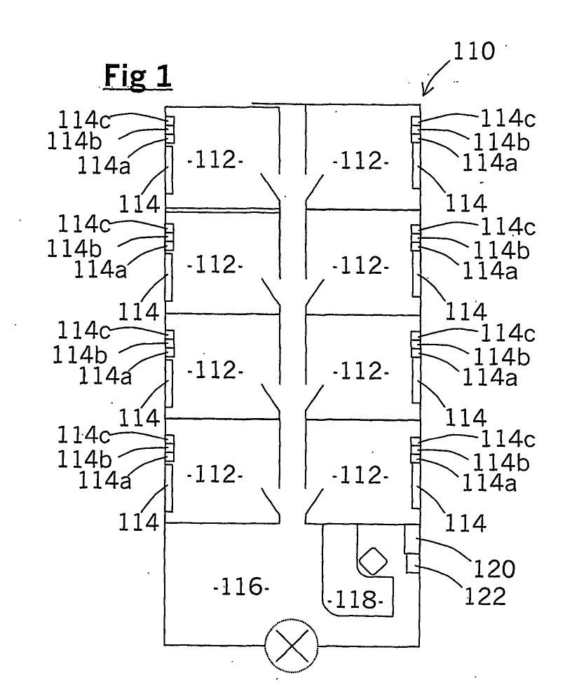

FIG. 1 shows a diagrammatic plan view of an office with central heating radiators controlled automatically by means of the invention;

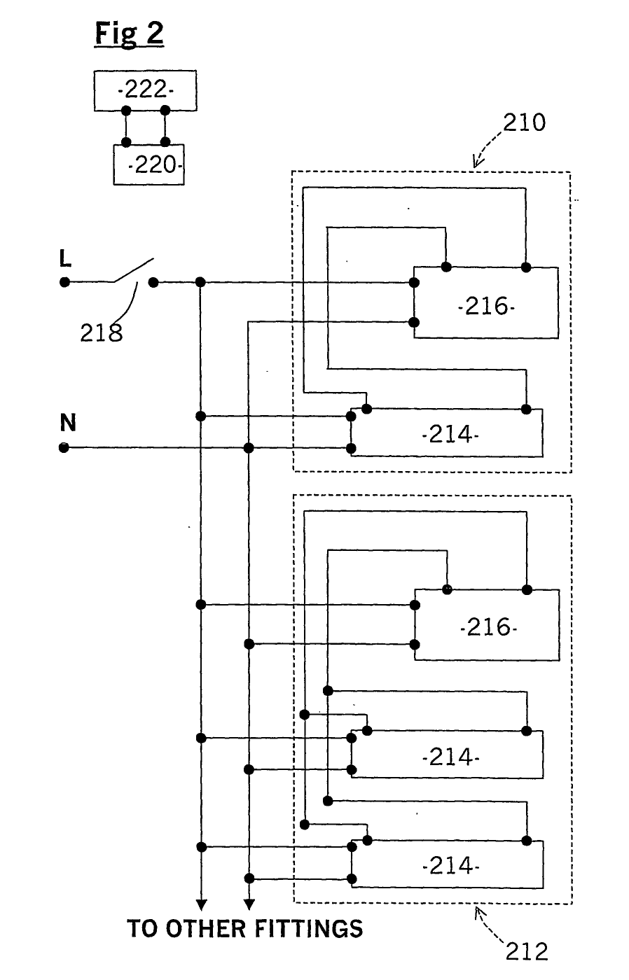

FIG. 2 shows a schematic block diagram of a control system for controlling fluorescent light fittings according to the invention; and

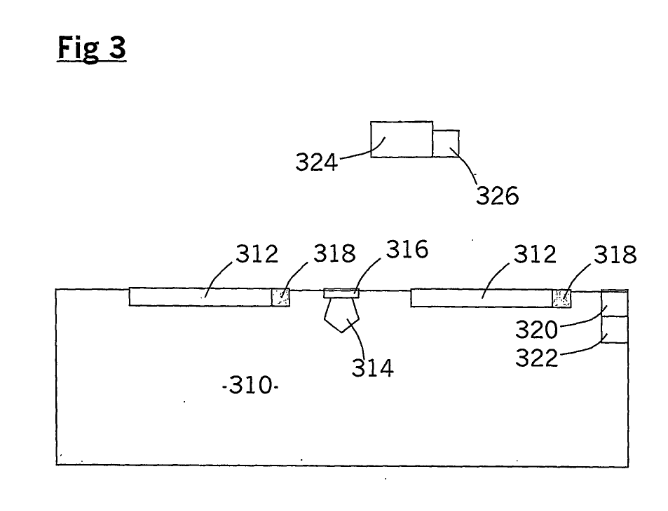

FIG. 3 is a diagrammatic side elevation of a corridor equipped with a person-detecting sensor arranged to control lighting in the corridor.

Referring first to FIG. 1, this shows a floor of a hotel indicated generally at 110 and comprising a plurality of rooms 112 each provided with a radiator 114 of a central heating system (not otherwise detailed, for simplicity of illustration) whereby the rooms 112 are heated. The hotel 110 has an entrance lobby 116 furnished in the usual way with a reception desk 118. Behind the desk 118, and therefore out of the way of guests, is a radio transmitter 120 operatively associated with a temperature sensor 122. The transmitter operates in the 868 MHz band.

Each of the radiators 114 is adjustable by means of an opening and closing valve 114a, in the usual way save that each valve is operated by a 0-10V dc stepper motor 114b. The stepper motors 114b are themselves controlled by radio receivers 114c in direct radio communication with the transmitter 120. If there is a fall in the temperature detected by the sensor 122, the transmitter 120 transmits to the receivers 114c a signal representative of the lower temperature, and this causes the stepper motors 114b to turn the radiator valves 114a towards (or further towards) their open position. Similarly, if there is a rise in the temperature detected by the sensor 122, the transmitter 120 transmits to the receivers 114c a signal representative of the higher temperature, and this causes the stepper motors 114b to turn the radiator valves 114a towards (or further towards) their closed position. Thus the heat output of the radiators 114 is varied in inverse relation to the sensed temperature.

The signal from the transmitter 120 may be an analogue representation of the sensed temperature, but in many cases it is sufficient and more convenient for the signal to be a step-wise approximation of the temperature.

FIG. 2 illustrates another use of the invention. It shows two remotely controlled fluorescent light fittings indicated in broken lines at 210 and 212. (As indicated in FIG. 2, there may be more light fittings similarly controlled). The two fittings 210 and 212 are of different sizes, fitting 210 comprising a single controllable tube (not detailed) and fitting 212 comprising two individually controllable tubes. The light outputs of the tubes are varied by means of 0-10V dimming ballasts 214 of well known form, which ballasts are operatively connected to radio receivers 216. The light fittings 210 and 212 are powered from live L and neutral N mains supply lines, the live L line including a switch 218 providing overall control.

Provided the switch 218 is closed to complete the live L supply, the light fittings 210 and 212 are remotely controlled as will now be described in more detail. A photometer 220 is arranged, remote from the light fittings 210 and 212, in such a position as to detect ambient light. A radio transmitter 222 communicating directly with the receivers 216 in the 868 MHz band is connected to the photometer 220 and transmits to the receivers 216 control signals representative of the light level detected by the photometer 220. If there is a fall in the ambient light level as detected by the photometer 220, the transmitter 222 transmits to the receivers 216 a signal representative of the lower light level, and this causes the dimming ballasts 214 to increase the light output from the fittings 210 and 212. Similarly, if there is a rise in the light level detected by the photometer 220, the transmitter 222 transmits to the receivers 216 a signal representative of the higher ambient light level temperature, and this causes the dimming ballasts 214 to decrease the light output from the fittings 210 and 212. Thus the light output of the fittings 210 and 212 is varied in inverse relation to the ambient light level.

The signal from the transmitter 222 may be an analogue representation of the ambient light level, but in practice step-wise adjustment over say 100 or more steps makes adjustment of the light output imperceptible to users.

FIG. 3 illustrates another use of the invention. It shows a corridor 310 equipped with two overhead lights 312. Prior to the introduction of the invention in this corridor 310, the lights 312 were operated manually from either of two wall switches located at opposite ends of the corridor 310. But despite the apparent convenience of this arrangement the lights 312 were often left on. Now, by means of the invention, the lights 312 operate automatically under the control of a passive infra-red detector 314 arranged to detect any person in the corridor 310. When this happens, a radio transmitter 316 associated with the detector 314 transmits a control signal. This control signal is received by receivers 318 associated with the lights 312 and causes a switch in the power supply to be closed automatically, switching the lights 312 on. Thus the lights 312 are switched on automatically, but only when needed. Thus power is saved.

A particular advantage of the arrangement of FIG. 3 is that the lights 312 are provided with automatic operation without the expense of rewiring or redecoration, since the detector 314 can be located for best visibility without concern for the location of the lights 312 and the wire-free arrangement can be installed without damage to the existing fabric.

A photometer 320 associated with another radio transmitter 322 sends control signals to the receivers 318 such that the lights 312 are not switched on if the ambient light level is sensed to be adequate. Thus control signals from the transmitter 322 can override those from the transmitter 316. Those skilled in the science will appreciate that the photometer 320 and its associated transmitter 322 may also be arranged to set the output of the lights 312, when switched on from the passive infra-red detector 314.

Further, a timer 324, which may conveniently be located outside the corridor 310 and may be part of a building management system (not detailed), is associated with a further radio transmitter 326. This is also arranged to send control signals to the receivers 318. The arrangement is such that the lights 312 are switched off, or their output reduced, if the passive infra-red detector 314 fails to detect the presence of a person in the corridor 310 for some predetermined period.

It is to be understood that heaters or other apparatus may be controlled in similar fashion to the lights 312, ie so that one sensor turns them on or up and another sensor turns them off or down. Other modifications will be apparent to those skilled in the science.

1. A control system for controlling apparatus remotely in response to a variable which is independent of the system and has a changing value, which system comprises a sensor to sense the value of the variable, a radio transmitter associated with the sensor and operative to transmit a control signal representative of the sensed value of the variable, a radio receiver associated with the controlled apparatus and operative to receive the control signal, and a controller operative by receipt of the control signal to control the apparatus according to the value of the variable.

2. A control system as claimed in claim 1 wherein the controller is operative to change a parameter of the controlled apparatus as the value of the variable changes.

3. A control system as claimed in claim 2 wherein the controller is operative to change said parameter proportionately as the value of the variable changes.

4. A control system as claimed in claim 2 wherein said parameter is changed in direct relation to the value of the variable.

5. A control system as claimed in claim 2 wherein said parameter is changed in inverse relation to the value of the variable.

6. A control system as claimed in claim 5 wherein the controlled apparatus comprises at least one lamp of which said parameter is the light output thereof.

7. A control system as claimed in claim 6 wherein the variable is ambient light and the sensor comprises a photometer, the system being arranged to increase the light output from the lamp as incident light on the photometer decreases.

8. A control system as claimed in claim 6 wherein the sensor senses the presence of a person and the system is arranged to operate in at least one of switching the lamp on and increasing the light output from the lamp, when the presence of a person is detected.

9. A control system as claimed in claim 7 including a timer operative in at least one of switching the lamp off and reducing the light output from the lamp, a predetermined period after the time when the presence of a person is last sensed.

10. A control system as claimed in claim 6 wherein the controller comprises an adjustable ballast.

11. A control system as claimed in claim 5 wherein the variable is ambient temperature.

12. A control system as claimed in claim 11 wherein the apparatus comprises at least one heater of which said parameter is heat output from the heater.

13. A control system as claimed in claim 12 wherein the sensor comprises a thermometer and the system is arranged to increase the heat output from the heater as ambient temperature at the thermometer decreases.

14. A control system as claimed in claim 2 wherein said parameter is changed in a plurality of steps.

15. A control system as claimed in claim 1 including a plurality of said sensors.

16. A control system as claimed in claim 1 including a plurality of said controllers.

17. A control system as claimed in claim 15 wherein at least one controller is operative in response to control signals from more than one sensor.

18. A control system as claimed in claim 17 wherein at least one controller is arranged to operate in one of switching the controlled apparatus on and increasing the output of the controlled apparatus, in response to a control signal from one said sensor and is arranged to operate in one of switchcing the controlled apparatus off and decreasing the output of the controlled apparatus, in response to a control signal from another said sensor.

19. A control system as claimed in claim 1 wherein at least one control signal is a radio signal in the 868 MHz band.

20. (canceled)
